(19) United States
(12) Patent Application Publication
(10) Pub. No.: US 2026/0044836 A1
(43) Pub. Date: Feb. 12, 2026

(54) METHOD AND SYSTEM FOR QUANTIFYING AN INDIVIDUAL'S SOCIAL FAME (SF) IN SOCIAL MEDIA

(71) Applicant: ProphetStor Data Services, Inc., Taichung (TW)

(72) Inventors: Wen-Shyen Chen, Taichung City (TW); Jonathan Chen, Milpitas, CA (US)

(21) Appl. No.: 18/799,367

(22) Filed: Aug. 9, 2024

(51) Int. Cl. G06Q 50/00

(52) U.S. Cl. CPC G06Q 50/01

(57) ABSTRACT

The present invention provides a method for quantifying an individual's Social Fame (SF) in social media and a system thereof. The method includes the following steps: collecting social media data of the individual from various social media platforms; assigning a weight parameter to each social media platform from which the social media data is collected; identifying whether a post or a response contained in the collected social media data is positive or negative by sentiment analysis performed by a generative AI model; and calculating the individual's SF score based on the collected social media data, the weight parameter of each social media platform, and the sentiment analysis results.

### FIELD OF THE INVENTION

The present invention relates to a method and a system for quantifying an individual's Social Fame (SF). More particularly, the present invention relates to a method and a system for quantifying an individual's Social Fame (SF) in the realm of social media.

### BACKGROUND OF THE INVENTION

In an increasingly interconnected digital landscape, social media platforms are pivotal for many human interactions, encompassing personal, professional, and societal dimensions. However, this is also accompanied by the following problems that need to be faced up to and solved:

Social media platforms have evolved into indispensable conduits for global communication, serving as hubs for exchanging ideas, opinions, and information. The meteoric rise in user engagement is fueled by advancements in mobile technology and the global expansion of internet accessibility. While social media's initial purpose was personal connectivity, it has metamorphosed into a versatile platform for professional networking, brand building, social activism, and more. This ubiquity and diverse user base have led to an increasingly complex digital landscape, where verifying user authenticity and content credibility has become critical.

A surge in malicious activities has accompanied the escalating popularity of social media platforms, often orchestrated by illegitimate users and automated bots. These entities engage in disinformation campaigns, spamming, and phishing, compromising the platform's integrity and degrading the user experience. Given their sophisticated evasion techniques and the high volume of interactions on these platforms, identifying and isolating these entities is a complex challenge. This challenge extends beyond technical hurdles to include ethical and legal considerations, necessitating a comprehensive, multi-layered strategy to ensure the authenticity of user interactions and content.

In light of the challenges above, there is a pressing need for a system that can incentivize positive behavior; provide a quantifiable measure of user reputation; and promote constructive and genuine interactions while acting as a deterrent against malicious activities, thereby building a community-rooted in trust and accountability by offering a tangible metric for user credibility and behavior. Moreover, it serves as a proactive measure against malicious activities, impacting users' perceived credibility and social standing on the platform.

In order to overcome the aforementioned problems, the present invention provides solutions to address social media platforms' multifaceted challenges, chiefly identifying legitimate users and incentivizing constructive behavioral paradigms, thereby innovatively amalgamating financial attributes with social reputations, creating a symbiotic digital ecosystem that enhances the authenticity and credibility of user interactions. The present invention enables users to capitalize on their social reputation for financial gains and vice versa, establishing a self-sustaining, incentivized digital social environment.

While the present invention leverages advanced algorithms for nuanced analysis, its primary focus is providing a comprehensive, dynamic, and precise framework for user reputation assessment. This approach transcends traditional reputation management systems by incorporating predictive analytics and machine learning techniques.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims. The following presents a simplified summary of one or more aspects of the present disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

The invention described herein addresses a pressing need within this complex ecosystem: developing a robust, reliable, and adaptive system for managing user reputation and mitigating the risks posed by illegitimate users and automated bots.

Central to this invention is a comprehensive strategy aimed at counteracting the proliferation of illegitimate users and automated bots, often the precursors of misinformation, spam, and other malicious activities that degrade the user experience and compromise the integrity of social media platforms. Through the application of advanced algorithms, the system is adept at identifying and isolating anomalous behavioral patterns characteristic of such entities, thereby facilitating their prompt identification and subsequent neutralization.

While the system does employ Generative AI algorithms to enhance its capabilities, the primary innovation lies in its holistic approach to user reputation management. This approach transcends the limitations of traditional heuristic-based models, offering a more dynamic, contextually aware, and predictive framework for evaluating and incentivizing user interactions within social media ecosystems.

Beyond its technical functionalities, the invention also serves a broader societal purpose. It aims to elevate the quality of digital social interactions by promoting authenticity and encouraging constructive engagement. By integrating a meticulously designed framework for user reputation management with targeted incentivization mechanisms, the invention holds the potential to significantly mitigate the challenges associated with user authenticity and positive engagement on social media platforms.

In summary, the invention constitutes a landmark development in social media operational paradigms. It introduces a robust, agile, and trustworthy system for comprehensive user reputation management and proactive behavior incentivization, emphasizing the effective mitigation of illegitimate users and bots. Doing so lays the groundwork for a more secure, authentic, and enriching digital social landscape.

The present invention provides a solution to overcome the aforementioned issues by the following ways:
1. The present invention accurately evaluates a user's reputation by scrutinizing several behavioral metrics via advanced algorithms facilitating a more profound understanding by simulating various scenarios, thereby aiding in predicting and analyzing user behavior under diverse conditions.
2. The present invention cultivates an ethos of positive user engagement. By linking the user reputation score with interaction quality, the system encourages adherence to constructive behavioral norms, enhancing the overall quality of discourse and interaction on the platform.
3. The present invention provides a scoring system that is inherently dynamic, allowing for periodic recalibration of user scores based on recent behavior. This feature ensures that reputation scores are updated to reflect current behavior, accurately representing user credibility.
4. The present invention provides a platform-independent system that underscores its versatility and broad applicability across various social media platforms, regardless of their specific architectural and user interface designs. This universal applicability amplifies its potential to cultivate a harmonious, genuine, and constructive community across various digital social landscapes. By implementing a robust framework for user reputation management, the system lays the foundation for a more transparent, reliable, and harmonious digital social ecosystem.

In one aspect, the present invention provides a method for quantifying an individual's Social Fame (SF) in social media which includes the steps of: collecting social media data of the individual from various social media platforms; assigning a weight parameter to each social media platform from which the social media data is collected; identifying whether a post or a response contained in the collected social media data is positive or negative by sentiment analysis performed by a generative AI model; and calculating the individual's SF score based on the collected social media data, the weight parameter of each social media platform, and the sentiment analysis results.

Preferably, the collected social media data includes a number of positive posts and a number of negative posts made by the individual on each social media platform during a specific period of time.

Preferably, the collected social media data includes a number of positive responses and a number of negative responses received by the individual on each social media platform during a specific period of time by a selected group of people.

Preferably, the collected social media data includes a number of positive responses made by the individual toward another person during a specific period of time.

Preferably, the individual's SF score decreases when the individual gives a positive response to another person.

Preferably, the SF score is calculated by multiplying the weight parameter assigned to each social media platform by the disparity between the quantity of positive and negative posts/responses collected during a specific time period, as determined by the sentiment analysis results.

Preferably, the SF score is dynamically updated according to the social media data which is collected in real-time.

Preferably, the SF score is dynamically adjusted and updated to a SF database and is displayed through an application programming interface (API) Gateway.

Preferably, the weight parameter assigned to each social media platform is based on a credibility score and a detrimental score thereof.

Preferably, the method further includes a step of: evaluating an activity level of the individual on each social media platform.

In another aspect, the present invention provides a system for quantifying an individual's Social Fame (SF) in social media which includes: a user database, for storing an individual's profile including current and historical SF scores; a social media data collector, network-connected to the user database and various social media platforms, for collecting social media data of the individual from various social media platforms; an AI integration engine, network-connected to the social media data collector, for identifying whether a post or a response contained in the collected social media data is positive or negative by sentiment analysis performed by a generative AI model; and a calculation engine, network-connected to the AI integration engine, for assigning a weight parameter to each social media platform from which the social media data is collected, and for calculating the individual's SF score based on the collected social media data, the weight parameter of each social media platform, and the sentiment analysis results.

Preferably, the collected social media data includes a number of positive posts and a number of negative posts made by the individual on each social media platform during a specific period of time.

Preferably, the collected social media data includes a number of positive responses and a number of negative responses received by the individual on each social media platform during a specific period of time by a selected group of people.

Preferably, the collected social media data includes a number of positive responses made by the individual toward another person during a specific period of time.

Preferably, the individual's SF score decreases when the individual gives a positive response to another person.

Preferably, the SF score is calculated by multiplying the weight parameter assigned to each social media platform by the disparity between the quantity of positive and negative posts/responses collected during a specific time period, as determined by the sentiment analysis results.

Preferably, the SF score is dynamically updated according to the social media data which is collected in real-time.

Preferably, the SF score is dynamically adjusted and updated to the user database and is displayed through an application programming interface (API) Gateway.

Preferably, the weight parameter assigned to each social media platform by the calculation engine is based on a credibility score and a detrimental score thereof.

Preferably, the calculation engine further evaluates an activity level of the individual on each social media platform.

### BRIEF DESCRIPTION OF THE DRAWINGS

FIG. 1 is a block diagram illustrating major components of a system for quantifying an individual's Social Fame (SF) in social media according to an embodiment of the present invention.

FIG. 2 is a flowchart illustrating a method for quantifying an individual's SF in social media according to an embodiment of the present invention.

FIG. 3 is a conceptual overview of the method according to an embodiment of the present invention.

FIG. 4 is an example of a user interface of an API Gateway according to an embodiment of the present invention.

### DETAILED DESCRIPTION OF THE PREFERRED EMBODIMENTS

The present invention will now be described more specifically with reference to the following embodiments. The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

The objectives of the present invention are to introduce a novel, quantifiable metric for Social Fame (SF); incorporate the influence of multiple social media platforms and interpersonal interactions; enhance computational efficiency through innovative caching techniques; and establish a proprietary method for calculating credibility and detrimental scores for each social media platform. Details will be further described in the following paragraphs.

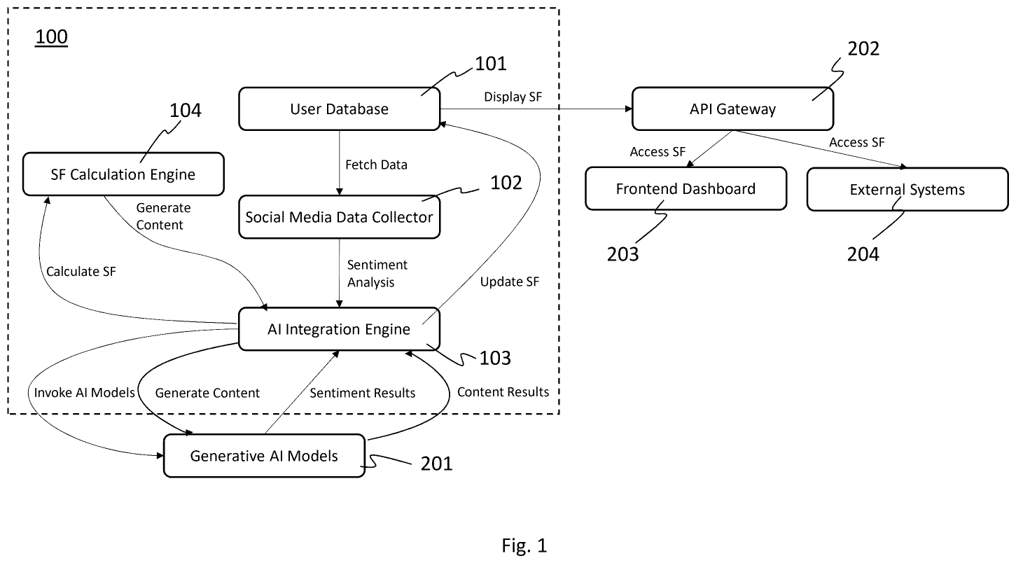

FIG. 1 is a block diagram illustrating major components of a system 100 for quantifying an individual's Social Fame (SF) in social media according to an embodiment of the present invention. As shown, the system 100 includes: a user database 101, a social media data collector 102, an AI integration engine 103, and a calculation engine 104. The user database 101 is the central repository where an individual's profile, user-related data, including their current and historical SF scores and other profile information, is securely stored. The social media data collector 102 is connected to both the user database 101 and various social media platforms. Its primary role is to collect social media data from these social media platforms that pertain to the individual in question and send the collected data to the AI Integration Engine 103 for initial processing. It may be in the form of an API or a web scraper. The AI integration engine 103, linked to the social media data collector 102, employs a generative AI model 201 to perform sentiment analysis on the collected social media data so as to determine whether posts or responses carry a positive or negative tone. The generative AI model 201 provides AI capabilities not only like sentiment analysis but also like content generation and automated responses. It can be pre-trained or a custom AI model designed for various tasks. It is invoked by the AI Integration Engine 103 to analyze and generate content.

The calculation engine 104 is network-connected to the AI integration engine 103 and is in charge of assigning weight parameters to each social media platform from which social media data is gathered. It then utilizes the collected social media data, in conjunction with the sentiment analysis results received from the AI integration engine 103, to compute the individual's SF score. The AI integration engine 103 works closely with the social media data collector 102 and the SF calculation engine 104. It receives raw data, processes it through the generative AI models 201, and then sends it to the SF calculation engine 104 for final SF calculation.

The collected social media data may include one of or a combination of the following parameters: a number of positive posts and a number of negative posts made by the individual on each social media platform during a specific period of time; a number of positive responses and a number of negative responses received by the individual on each social media platform during a specific period of time by a selected group of people; and/or a number of positive responses made by the individual toward another person during a specific period of time.

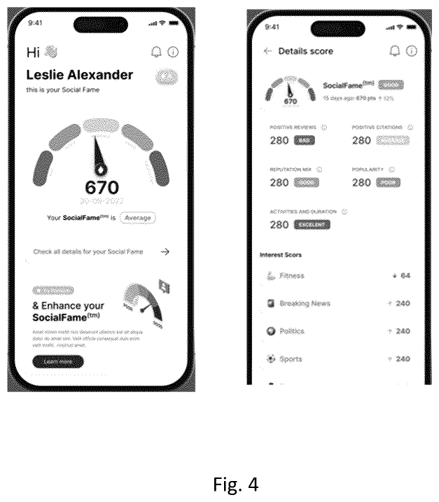

The SF score is primarily computed by multiplying the weight parameter assigned to each social media platform by the disparity between the quantity of positive and negative posts/responses collected during a specific time period, as determined by the sentiment analysis results. Notably, the SF score is subject to dynamic updates based on real-time collection of social media data. These dynamic adjustments to the SF score are seamlessly integrated with the user database 101 and are accessible through an application programming interface (API) Gateway 202, as shown in FIG. 4. Importantly, it's worth noting that the individual's SF score experiences a decrement when they provide a positive response to another individual. The weight parameters assigned to each social media platform by the calculation engine 104 are typically derived from a credibility score and its detrimental counterpart. Additionally, the calculation engine 104 conducts an assessment of the individual's activity level on each social media platform to further refine the SF score.

The application programming interface (API) Gateway 202 includes various APIs for both external and internal use. It communicates with the user database 101 and the AI integration engine 103 to fetch and update data. It serves as an interface for a frontend dashboard 203 and an external system(s) 204 to be able to communicate or interact with the system 100. It also can act as an endpoint for fetching and updating SF scores, user profiles, and other functionalities. The individual's SF score can be easily obtained through an API of the API Gateway 202 via the frontend dashboard 203 which provides a user interface for a user to view the SF scores and/or related analytics in a form of charts, tables, lists, etc., as shown in FIG. 4. The external system(s) 204 is/are able to fetche the SF scores through the API Gateway 202. The external system(s) 204 represents a third-party system(s) such as a financial institution or an admission office, that might make evaluations in view of the SF score. For instance, the financial institution might employ the SF score for assessing creditworthiness, while the admission office could utilize it to enhance their insight into an applicant's profile during the admissions process.

The AI integration engine 103, working in tandem with the generative AI model 201, is capable of delivering the following functionalities:
1. Sentiment Analysis: This function identifies and contextualizes the emotional tone of posts and comments, thereby providing a more nuanced understanding of public sentiment towards an individual.
2. Personality Classification: By classifying the characteristics of individuals based on their social media activity, the system can offer a more comprehensive SF score that reflects not just popularity but also personal attributes like trustworthiness, reliability, and charisma.
3. Content Generation: Generative AI can create personalized content or responses to improve an individual's SF. This could be particularly useful for public figures or organizations looking to enhance their online reputation.
4. Fake News and Disinformation Detection: Generative AI can be trained to identify patterns typical of fake news or disinformation, ensuring that SF scores are not manipulated or artificially inflated.
5. Dynamic Adaptability: Generative AI allows the system to adapt to changing social norms and trends. As societal values shift, the AI models can be retrained to reflect these changes, ensuring that SF scores remain relevant and accurate.
6. Personalized Feedback: The AI can generate personalized recommendations for individuals on improving their SF, making the system a passive measurement tool and an active personal development agent.
7. Ethical Considerations: Using AI to identify and flag potentially harmful or misleading content can increase ethical social media usage. This is particularly important in today's digital age, where the impact of online behavior is significant.
8. Enhanced Credibility: AI for sentiment analysis and personality classification adds a layer of credibility to the SF scores, making them more reliable indicators of social standing, which is crucial for external systems like financial institutions and admission offices.

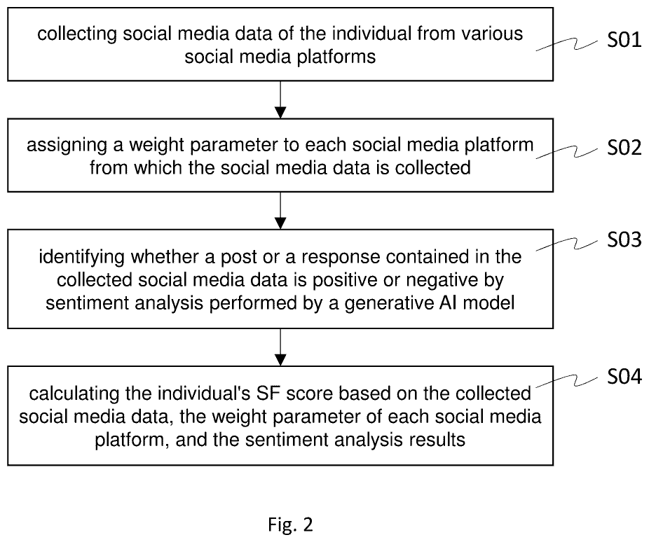

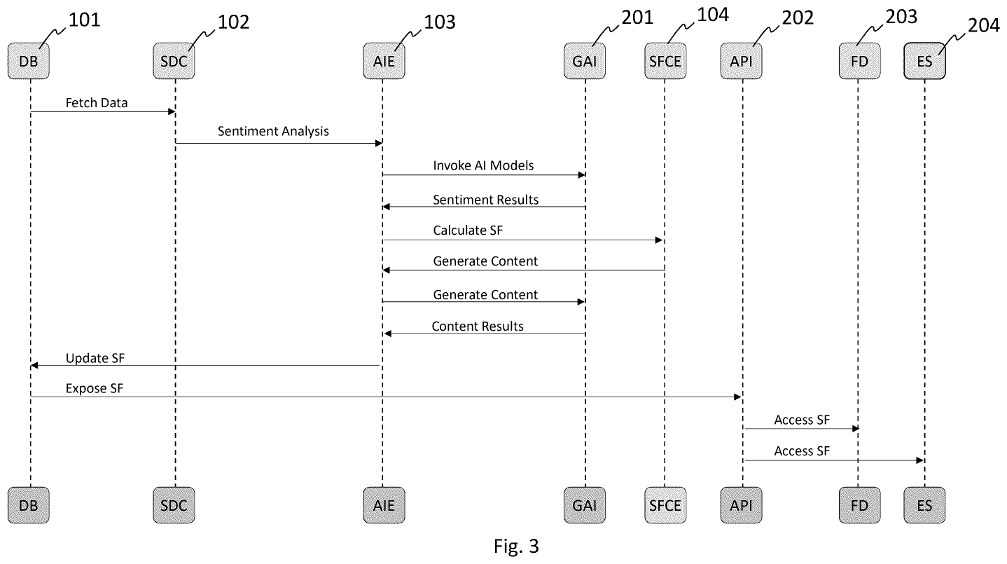

For a better understanding of the present invention, please refer to FIG. 2 which is a flowchart illustrating a method for quantifying an individual's Social Fame (SF) in social media according to an embodiment of the present invention, along with FIG. 3 which provides a conceptual overview of the method and FIG. 4 which is an example of the user interface of an API Gateway.

The method, as outlined in the invention, in short proceeds through the following steps: In step S01, social media data of an individual is systematically gathered, preferably in real-time, from a variety of social media platforms via the social media data collector 102. This includes but is not limited to posts, responses, and other forms of user-generated content. The collected/gathered social media data is then sent to the AI integration engine 103 by the social media data collector 102 to further process. Step S02 involves the assignment of distinct weight parameters to each social media platform from which the social media data was collected. These weight parameters reflect the relative significance of each platform in the context of the individual's SF calculation. The subsequent step, identified as step S03, encompasses the application of sentiment analysis. The collected social media data is sent to generative AI model(s) 201 via the AI integration engine 103. The sentiment analysis is then performed by the generative AI model(s) 201, which determines whether a given post or response within the collected social media data conveys a positive or negative sentiment. The sentiment analysis results are afterward sent back to the AI integration engine 103 so that it could be forward to the calculation engine 104. It should be noted that step S03 can alternatively be placed before step S02. Finally, in step S04, the individual's SF score is computed by the calculation engine 104. This calculation integrates the collected social media data, the assigned weight parameters for each platform, and the results of the sentiment analysis. The SF score is a measure of the individual's prominence, influence, and sentiment impact within the social media landscape.

In addition to the aforementioned steps, a step of evaluating an activity level of the individual on each social media platform can also be included. Details will be lateron described. Moreover, the AI integration engine 103 not only updates the SF score to the user database 101 but also is able to generate personalized content or automated responses to optimize the individual's SF score, if desired, preferably by use of the generative AI model(s) 201.

For a more comprehensive grasp of the present invention, below is an exemplary formula used to calculate an individual's Social Fame (SF) score. It should be realized that this is merely an example and the present invention is not limited thereto. The Social Fame (SF) for an individual, denoted as x, during a specific period of time t, is computed using a recursive formula. For ease of comprehension, the formula is segmented into four sections which could be selectively included:

$$SF ( x , t ) = {\sum }_{y ∈ S} [ {w}_{y} \times ( {c}_{y} \times ( {PosPosts}_{x , y , t} - {NegPosts}_{x , y , t} ) ) ] + {\sum }_{p ∈ P} [ SF ( p , t ) \times ( {PosResp}_{x , p , t} - {NegResp}_{x , p , t} ) ] - {\sum }_{y ∈ S} [ {w}_{y} \times ( {d}_{y} \times activity ( x , y ) ) ] - {S}_{I} \times {\sum }_{p ∈ P} [ S F ( p , t ) \times {PosRespGiven}_{x , p , t} ]$$

Below are definitions for each variable in the above formula:
x: The individual whose Social Fame is being calculated.
t: The specific period of time at which the Social Fame is being calculated.
y: A specific social media platform in the set S.
S: The set of social media platforms considered.
p: A specific person in the set P.
P: The set of people we are interested in.
w_{y}: Weight of social media platform y in the set S.
c_{y}: Credibility score of social media platform y.
d_{y}: Detrimental score of social media platform y.
S_{I}: Penalty score for an influencer when they give positive responses.
PosPosts_{x,y,t}: Number of positive posts by x on social media y at time t.
NegPosts_{x,y,t}: Number of negative posts by x on social media y at time t.
PosResp_{x,p,t}: Number of positive responses received by x from person p at time t.
NegResp_{x,p,t}: Number of negative responses received by x from person p at time t.
PosRespGiven_{x,p,t}: Number of positive responses given by x to person p at time t.
activity(x,y): Overall activity level of x on social media y.

In this particular embodiment, several underlying assumptions may be selectively made: Social Fame (SF) is a measurable metric that is shaped by an individual's activities on social media and their interactions with others; the SF of an individual can exert an influence on the SF of others, resulting in a recursive calculation process; both social media platforms and individuals are assigned credibility scores; engagement on specific social media platforms can potentially negatively impact an individual's SF; the system is capable of optimizing the recursive calculation through the use of caching techniques; and each social media platform is associated with a weight parameter denoted as “w_y” that reflects its significance in the SF calculation.

The Social Fame Formula provided in this patent application is to be understood as an exemplary embodiment of the underlying mathematical and computational principles that govern the Social Fame System (SFS). It is not intended to limit or restrict the scope of the invention to this specific formulaic representation. The architecture of the SFS is designed to be modular and extensible, allowing for the incorporation of various algorithms, computational models, and scoring mechanisms. This flexibility enables the system to adapt to evolving technological landscapes and user behaviors, maintaining its efficacy and relevance. The formula can be modified, extended, or replaced by alternative mathematical models or algorithms without deviating from the core objectives and functionalities of the SFS. Therefore, the scope of this patent should not be construed as being limited to any particular formula but rather should be interpreted as encompassing any variations, modifications, or equivalents that fall within the purview of the inventive concept. To gain a clearer insight into the formula, each of the four segments within the formula is described individually.

$$Segment 1 :$$

$${\sum }_{y ∈ S} [ {w}_{y} \times ( {c}_{y} \times ( {PosPosts}_{x , y , t} - {NegPosts}_{x , y , t} ) ) ]$$

This segment calculates the net influence of an individual's posts on various social media platforms. It takes into account the number of positive posts (PosPosts_{x,y,t}) and negative posts (NegPosts_{x,y,t}) made by the individual x on each social media platform y at time t. The credibility score c_{y} and the weight w_{y} of each platform are also considered. By using Generative AI models for sentiment analysis, the SF system can identify the emotional tone of posts and comments and also allows the system to adapt to changing social norms and trends, ensuring that the SF remains a fair and current metric. This can be a preliminary step in flagging potential fake news. The c_{y} term in the formula represents the credibility score of a social media platform. Platforms known for propagating fake news can be assigned a low c_{y}, thus reducing the SF of individuals who frequently post there. The recursive aspect of the formula means that if a highly credible individual flags a post as fake news, the SF of the individual who posted it will be significantly impacted, discouraging the spread of misinformation.

$$Segment 2 :$$

$${\sum }_{p ∈ P} [ SF ( p , t ) \times ( {PosResp}_{x , p , t} - {NegResp}_{x , p , t} ) ]$$

This segment calculates the influence of responses received by the individual x from other people p in the set P. It considers both positive (PosResp_{x,p,t}) and negative responses (NegResp_{x,p,t}) at time t. The term is weighted by the SF of the person p giving the response, making it recursive.

$$Segment 3 :$$

$$- {\sum }_{y ∈ S} [ {w}_{y} \times ( {d}_{y} \times activity ( x , y ) ) ]$$

This segment accounts for the detrimental effect of an individual's activity level on each social media platform y. The activity level is represented by activity (x,y), and d_{y} is the detrimental score for the platform. The term is also weighted by w_{y}, the weight of each platform. The activity (x,y) term can be used to monitor unusual spikes in activity, which could be indicative of fraudulent behavior, such as bot-controlled accounts. The w_{y} term allows the system to weigh the contributions from different platforms differently, ensuring that more credible platforms have a greater impact on an individual's SF.

$$Segment 4 :$$

$$- {S}_{I} \times {\sum }_{p ∈ P} [ SF ( p , t ) \times {PosRespGiven}_{x , p , t} ]$$

This segment penalizes influencers who give out positive responses to artificially inflate others' SF scores. PosRespGiven_{x,p,t} is the number of positive responses given by x to p at time t. S_{I} is the penalty score for an influencer when they give positive responses. The S_{I} term penalizes influencers who give out positive responses to artificially inflate others' SF scores, making it harder to game the system.

Through the integration of these four elements, the SF formula establishes a robust, automated, and impartial system for assessing individual credibility. This system proves invaluable in the fight against misinformation and fake news, fraud prevention, and equitable evaluations. Its computational and automated nature allows for audits and adjustments, ensuring transparency in the credibility assessment process. Furthermore, the formula is engineered for scalable, automated computation, making it capable of evaluating the SF of a substantial number of individuals. Additionally, the system possesses real-time social media data analysis capabilities, rendering it highly responsive to current events.

Social Fame is not merely an abstract metric but a transformative tool with multi-sectoral applications. Below are the key benefits of the present invention:

### For Financial Institutions:

1. Enhanced Creditworthiness Assessment: Traditional credit scoring may not provide a complete picture of an individual's financial responsibility. SF can complement these metrics, offering a more holistic view of a person's creditworthiness based on their social interactions and online behavior.
2. Effective Risk Management: SF can help identify high-risk individuals, assisting financial institutions in developing strategies to mitigate risks.
3. Tailored Customer Segmentation: Customizing financial products based on SF scores enables more personalized and efficient marketing.
4. Community Engagement: SF can pinpoint community leaders and influencers, bolstering brand image and fostering customer loyalty.

### For Academic Admission Offices:

1. Comprehensive Applicant Evaluation: SF supplements traditional evaluation criteria like grades and test scores, providing a more well-rounded assessment of applicants.
2. Assessing Cultural Fit: SF can gauge how well a prospective student aligns with the campus culture.
3. Alumni Relations Enhancement: SF scores of alumni can serve as a novel means to engage them in campus activities and fundraising efforts.

### Regarding Credibility of Posts:

1. Enhanced Trustworthiness: A high SF score can lend greater credibility to an individual's online statements.
2. Quantifying Influence: SF can quantify the impact of a post or article.
3. Monetization Opportunities: High SF scores may present opportunities for monetization, encouraging the production of quality content.

### In Identifying Fake News:

1. Source Reliability Assessment: SF can assess the trustworthiness of news sources.
2. Real-time Credibility Analysis: SF algorithms can provide real-time assessments of the credibility of trending news stories.
3. Informing the Public: SF scores can inform users about the credibility of news sources.

### In Fostering Community Acceptance:

1. Promoting Social Cohesion: SF identifies individuals who contribute positively to a community.
2. Supporting Conflict Resolution: SF can pinpoint critical influencers for conflict resolution and community moderation.

### For Regulatory Compliance:

1. Ensuring Transparency: SF can align with data protection and privacy regulations.
2. Upholding Ethical Standards: SF can be an ethical tool that offers a fair, unbiased assessment of social credibility while adhering to ethical principles.

In summary, the present invention may be used in various sectors by providing a holistic understanding of individual and collective behavior. Its integration can lead to more informed decision-making processes, enhance personalization, improve risk assessment, and improve systems' overall efficiency and effectiveness. The present invention is not merely an advancement in social media analytics but a transformative framework with far-reaching implications across various sectors, from financial institutions to academic settings. By the integration of generative AI models, the present invention provides an elevation in the system's capabilities in data analysis, content generation, and real-time optimization, thereby providing a robust, scalable, and efficient solution for quantifying and optimizing Social Fame. Moreover, the system is designed with ethical considerations and regulatory compliance in mind, ensuring that it respects individual privacy while offering a transparent and unbiased assessment of social credibility. In summary, the present invention represents a significant leap forward in social analytics and personal assessment. Its innovative architecture and the integration of AI make it a highly scalable and adaptable solution, poised to revolutionize how we understand and interact with social data. This patent application is a foundational document for what promises to be a transformative technology, setting the stage for future research, development, and implementation.

The Social Fame System (SFS) built based on the present invention serves as a revolutionary framework for quantifying and leveraging reputation within various digital ecosystems, not limited to social media. This system creates a self-sustaining loop where reputation scores and financial attributes are intricately linked, mutually reinforcing each other. The architecture of SFS is designed to be platform-agnostic, allowing for its universal applicability across various digital platforms with different foundational architectures. The system includes a Data Collection and Analytics Module, Integration APIs, and an Administration and Monitoring Module, which collectively facilitate seamless integration, robust data interchange, and comprehensive oversight. Customizable parameters are also integrated into the system, offering tailored adaptations to meet different digital ecosystems' specific needs and priorities. The system incorporates Generative Artificial Intelligence (GAI) to augment its capabilities. GAI enhances the system by providing advanced analytics and predictive modeling, adding a nuanced, dynamic layer to assessing user reputation. By addressing the challenges prevalent in various digital ecosystems, SFS aims to significantly improve the authenticity, trustworthiness, and quality of interactions within these platforms. The inclusion of GAI serves to amplify these benefits, contributing substantially to digital responsibility, financial inclusivity, and constructive discourse in the digital age.

It is to be understood that the specific order or hierarchy of steps in the methods disclosed is an illustration of exemplary processes and may be rearranged based upon design preferences. The accompanying method claims present elements of the various steps in a sample order, and are not meant to be limited to the specific order or hierarchy presented unless specifically recited therein.

Although embodiments have been described herein with respect to particular configurations and sequences of operations, it should be understood that alternative embodiments may add, omit, or change elements, operations and the like. Accordingly, the embodiments disclosed herein are meant to be examples and not limitations.

What is claimed is:

1. A method for quantifying an individual's Social Fame (SF) in social media, comprising the steps of:
collecting social media data of the individual from various social media platforms;
assigning a weight parameter to each social media platform from which the social media data is collected;
identifying whether a post or a response contained in the collected social media data is positive or negative by sentiment analysis performed by a generative AI model; and
calculating the individual's SF score based on the collected social media data, the weight parameter of each social media platform, and sentiment analysis results.

2. The method according to claim 1, wherein the collected social media data comprises a number of positive posts and a number of negative posts made by the individual on each social media platform during a specific period of time.

3. The method according to claim 1, wherein the collected social media data comprises a number of positive responses and a number of negative responses received by the individual on each social media platform during a specific period of time by a selected group of people.

4. The method according to claim 1, wherein the collected social media data comprises a number of positive responses made by the individual toward another person during a specific period of time.

5. The method according to claim 1, wherein the individual's SF score decreases when the individual gives a positive response to another person.

6. The method according to claim 1, wherein the SF score is calculated by multiplying the weight parameter assigned to each social media platform by the disparity between the quantity of positive and negative posts/responses collected during a specific time period, as determined by the sentiment analysis results.

7. The method according to claim 1, wherein the SF score is dynamically updated according to the social media data which is collected in real-time.

8. The method according to claim 1, wherein the SF score is dynamically adjusted and updated to a SF database and is displayed through an application programming interface (API) Gateway.

9. The method according to claim 1, wherein the weight parameter assigned to each social media platform is based on a credibility score and a detrimental score thereof.

10. The method according to claim 1, further comprising a step of:
evaluating an activity level of the individual on each social media platform.

11. A system for quantifying an individual's Social Fame (SF) in social media, comprising:
a user database, for storing an individual's profile including current and historical SF scores;
a social media data collector, network-connected to the user database and various social media platforms, for collecting social media data of the individual from various social media platforms;
an AI integration engine, network-connected to the social media data collector, for identifying whether a post or a response contained in the collected social media data is positive or negative by sentiment analysis performed by a generative AI model; and
a calculation engine, network-connected to the AI integration engine, for assigning a weight parameter to each social media platform from which the social media data is collected, and for calculating the individual's SF score based on the collected social media data, the weight parameter of each social media platform, and the sentiment analysis results.

12. The system according to claim 11, wherein the collected social media data comprises a number of positive posts and a number of negative posts made by the individual on each social media platform during a specific period of time.

13. The system according to claim 11, wherein the collected social media data comprises a number of positive responses and a number of negative responses received by the individual on each social media platform during a specific period of time by a selected group of people.

14. The system according to claim 11, wherein the collected social media data comprises a number of positive responses made by the individual toward another person during a specific period of time.

15. The system according to claim 11, wherein the individual's SF score decreases when the individual gives a positive response to another person.

16. The system according to claim 11, wherein the SF score is calculated by multiplying the weight parameter assigned to each social media platform by the disparity between the quantity of positive and negative posts/responses collected during a specific time period, as determined by the sentiment analysis results.

17. The system according to claim 11, wherein the SF score is dynamically updated according to the social media data which is collected in real-time.

18. The system according to claim 11, wherein the SF score is dynamically adjusted and updated to the user database and is displayed through an application programming interface (API) Gateway.

19. The system according to claim 11, wherein the weight parameter assigned to each social media platform by the calculation engine is based on a credibility score and a detrimental score thereof.

20. The system according to claim 11, wherein the calculation engine further evaluates an activity level of the individual on each social media platform.
